(19) United States
(12) Patent Application Publication
(10) Pub. No.: US 2025/0087175 A1
(43) Pub. Date: Mar. 13, 2025

(54) Microfluid Display Devices and Methods of Use

(71) Applicant: Ryan Zacheree Lewis, Seattle, WA (US)

(72) Inventor: Ryan Zacheree Lewis, Seattle, WA (US)

(21) Appl. No.: 18/829,069

(22) Filed: Sep. 9, 2024

Related U.S. Application Data
(60) Provisional application No. 63/581,788, filed on Sep. 11, 2023.

(51) Int. Cl. G09G 3/34; G02B 26/00; G09G 3/00; G09G 3/20

(52) U.S. Cl. CPC G09G 3/3433; G02B 26/004; G02B 26/007; G09G 3/035; G09G 3/2007; G09G 2300/08; G09G 2330/021; G09G 2360/144; G09G 2380/00

(57) ABSTRACT

This disclosure pertains to a fluid-based display device that uses immiscible fluids within pixel chambers to produce and control colors without the need for traditional backlights or filters. Actuators to move the fluids to display desired colors, managed by a microprocessor for precise control. The display can be integrated into flexible substrates, making it ideal for wearable technology. The system adjusts colors dynamically based on ambient light, enhancing visibility and energy efficiency.

### CROSS-REFERENCE TO RELATED APPLICATIONS

This application claims the benefit and priority of U.S. Provisional Application 63/581,788, filed on Sep. 11, 2023, which is hereby incorporated by reference in its entirety, including all references and appendices cited therein.

### FIELD

The present disclosure pertains broadly to systems and methods for fluid-based display technologies, specifically involving the manipulation of immiscible fluids within pixel chambers to control color display for various applications, including wearable devices.

### SUMMARY

One embodiment includes a fluid-based display. The fluid-based display device also includes a plurality of pixels, each pixel may include a chamber; a first fluid of a first color and a second fluid of a second color and immiscible with the first fluid, within the chamber; and an actuator configured to move the first and second fluids within the chamber to display a desired color, where the actuator is a fluidic actuator configured to control fluid movement and thereby control the first and second fluids within each pixel. Other embodiments of this aspect include corresponding computer systems, apparatus, and computer programs recorded on one or more computer storage devices, each configured to perform the actions of the methods.

Implementations may include one or more of the following features. The display device where the actuator may include a micro-pump or other fluidic actuator associated with each pixel, configured to alternately move the first fluid and the second fluid in and out of the chamber. The display device may include a microprocessor programmed to control the actuator based on input data. The pixels are arranged in an active-matrix configuration, with individual actuators provided for each pixel. The display device may include a sensor configured to detect a position of the first and second fluids within the chamber and adjust the actuator accordingly. The device includes a flexible substrate. The second fluid is transparent, and the movement of the first and second fluids is used to control shading or grey-scale effects by modulating an amount of light passing through the pixel. One or more additives, such as surfactants, stabilizers, or particles, are added to at least one of the fluids to render the fluids immiscible, preventing coalescence and maintaining fluid separation. The display device may include a color filter positioned over the pixel to enable additional color combinations when displaying colors. The display device may include a backlight system configured to modulate the amount of light passing through the pixel to enhance display visibility. The pixel includes a reflective or colored material positioned at a bottom of the chamber to enhance a brightness or provide color effects. Implementations of the described techniques may include hardware, a method or process, or computer software on a computer-accessible medium.

The wearable display system also includes a flexible substrate; a plurality of microfluidic pixels embedded within the flexible substrate, each pixel may include at least two immiscible fluids of different colors or a combination of a transparent and colored fluid; and an actuator system integrated into the flexible substrate, configured to control the position of the immiscible fluids within the pixels to display different colors or shades; and a microprocessor programmed to control the actuator system based on input signals. Other embodiments of this aspect include corresponding computer systems, apparatus, and computer programs recorded on one or more computer storage devices, each configured to perform the actions of the methods.

Implementations may include one or more of the following features. The wearable display system may include a sensor for detecting ambient light conditions and adjusting the colors or shades displayed by the pixels accordingly. The system includes a power source embedded within the flexible substrate to power the actuator system and the microprocessor. The flexible substrate is configured to conform to non-planar surfaces, allowing the display to be integrated into wearable devices or other curved surfaces. The flexible substrate is composed of a material selected from polymers, elastomers, or composite materials. The wearable display system may include microfluidic channels embedded within the flexible substrate, configured to transport the fluids between different pixels across the display. The flexible substrate allows the wearable display system to be woven into fabrics for integration into textiles and wearable electronics. The flexible substrate includes a protective layer configured to shield the display from environmental factors including moisture, dust, and/or physical impact. Implementations of the described techniques may include hardware, a method or process, or computer software on a computer-accessible medium.

### BRIEF DESCRIPTION OF THE DRAWINGS

FIG. 1 is a top-down view of a 2×2 pixel display showing the layout of fluid chambers and microchannels.

FIG. 2 is a top-down transparent view of an active-matrix configuration where each pixel has individual actuators for fluid control.

FIG. 3 is a cross-sectional view along line A-A of FIG. 2, illustrating the arrangement of sub-chambers and through holes for fluid movement.

FIG. 4 is a top-down view of a passive matrix configuration where rows and columns of pixels are fluidically connected.

FIG. 5 is a transparent view of the passive matrix layout showing the placement of actuators along microfluidic channels.

FIGS. 6 and 7 are cross-sectional views of the passive matrix display, illustrating fluid channels at different depths within the display.

FIG. 8 is a cross-sectional view of a pixel showing how fluid movement can control light transmission when paired with a backlight.

FIG. 9 is a cross-sectional view showing how multiple immiscible fluids can be used within a pixel to achieve color combinations.

FIG. 10 is a top-down view of the display device configured as a flexible, color-changing material integrated into a substrate.

FIG. 11 is a schematic view of a computer system that can be used in accordance with the present disclosure.

### DETAILED DESCRIPTION OF EXAMPLE EMBODIMENTS

### Overview

In the display market today, there are three major categories of displays; emissive, transmissive and reflective. Emissive displays are some of the most common and are used in technologies such as OLED. These emit light and control the color of each pixel by modulating the intensity of colored (typically RGB) sub-pixels. Although this allows for a large color gamut, high refresh rates, and good contrast, it does have its limitations. Given the large number of layers within the display, it can be expensive and in addition these displays do not work well under direct light or sunlight. They also suffer from a phenomenon called burn in. Transmissive displays such as LCD technology are lit from a backlight source where the amount of light that passes through the LCD is controlled by liquid crystals. It then uses color filters to produce a range of colors. Although this technology is more cost effective than OLED and is bright, it suffers from lower contrast levels and poor visibility under sunlight as well.

That is where reflective displays come in, this technology performs very well under high ambient light conditions as the higher the ambient light, the better the display looks. In addition, the viewing angle is greater. However typical reflective technology can suffer greatly from the lack of contrast, limited color range, ghosting images, low brightness and slow refresh rates. Most of these displays are only black and white. To achieve a full color display, a color filter is typically required which leaves the image looking washed since sub colors of the pixel (RGB or CMYK) each share ⅓ of the pixel. This diminishes the effective area a color can use and hence brightness. Emissive displays do not suffer from this since the brightness for any color can be increased.

The present disclosure relates to an innovative fluid-based display technology designed to overcome the limitations of traditional display systems. This technology employs immiscible fluids within individual pixel chambers to produce and control colors, eliminating the need for conventional backlights, polarizers, or color filters. The system utilizes various types of actuators, such as piezoelectric, electro-wetting, electrostatic, thermal, or electromagnetic mechanisms, which precisely move the fluids within each pixel to achieve the desired color output.

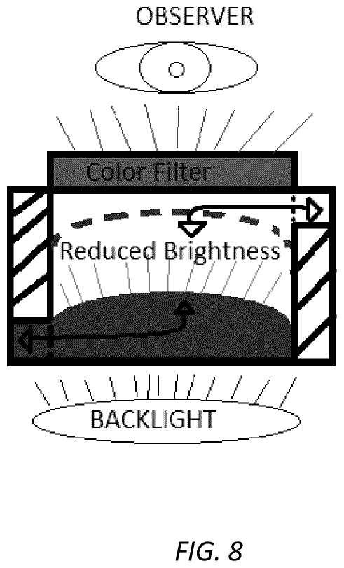

Exemplar features of the disclosed technology include the ability to dynamically adjust fluid positions to optimize color display based on ambient light conditions (see FIG. 8 as an example), enhancing visibility and reducing power consumption. The use of immiscible fluids enables full-pixel color filling, improving color accuracy and brightness compared to traditional methods that rely on color filters with limited fill factors.

One of the inventive concepts of this technology is its flexibility, allowing the display system to be integrated into a variety of substrates, including flexible and non-rigid materials suitable for wearable technology. The display can be woven into fabrics or laminated onto surfaces, making it ideal for applications where traditional rigid displays are impractical.

Additionally, the system includes a microprocessor that controls the actuators, enabling complex color mixing and pattern generation based on real-time input data. Sensors can be integrated to monitor fluid positions and adjust the display accordingly, ensuring consistent performance even in dynamic environments. This combination of fluid-based color control, actuator-driven fluid movement, and flexible integration represents a significant advancement in display technology, offering new possibilities for wearable electronics, adaptive displays, and energy-efficient visual output systems.

### EXAMPLE EMBODIMENTS

The following is a detailed description of the illustrative embodiments of the present invention. As shown in the figures, this invention can act as a display in both reflective and transmissive mode, when paired with a backlight device. There are key advantages to this device that other technologies do not have. Compared with other reflective technologies such as e-paper, this device allows for complete pixel filling using a variety of possible working fluids such as inks, pigment dispersed liquids, dyes and much more. Other technologies may simply use dispersed charged colored particles, or others that don't use colored particles but rely on interference of wavelengths to create color. In addition, this device can be made to be bistable which means that power is not required to maintain the state of the fluid in the pixel. Other advantages include the increased contrast and ability to completely block light from a backlight giving it true blacks which other technologies such as LCD suffer from.

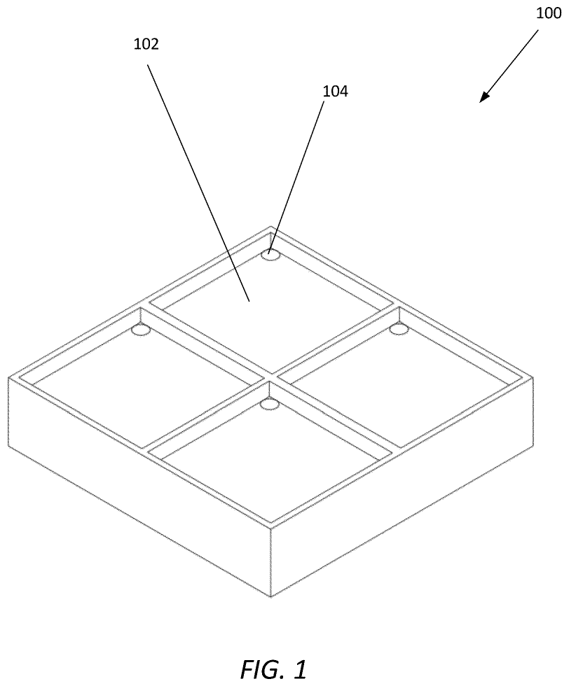

FIG. 1 illustrates a 2×2 pixel display 100 of an example device with the top layer removed, revealing the layout of fluid chambers 102 and vias/through-holes 104 that are in fluid communication with microchannels. The fluid chambers act as reservoirs for the fluids, while the microchannels direct these fluids into the visible pixel regions through through-holes that originate from concealed areas.

This design enables high-quality display performance with only a simple transparent top layer, which serves as a protective cover and helps maintain brightness and color accuracy. Unlike traditional displays that require multiple additional layers—such as electrodes, conductive materials, and color filters—this device avoids those complexities, which can lead to internal light reflection and a reduction in image quality.

The device achieves a simplified construction by minimizing the need for additional layers, though some embodiments may include them as optional features depending on the application. The microchambers and microchannels are designed to precisely control the movement of fluids into the visible pixel regions, ensuring consistent and accurate color output. The display can be configured in an active-matrix style, where each pixel's color is individually controlled by its own actuator. This configuration allows for precise modulation of fluid movement within each pixel, enhancing the display's responsiveness and overall color accuracy compared to traditional display technologies. Additionally, the absence of unnecessary layers contributes to improved brightness and energy efficiency.

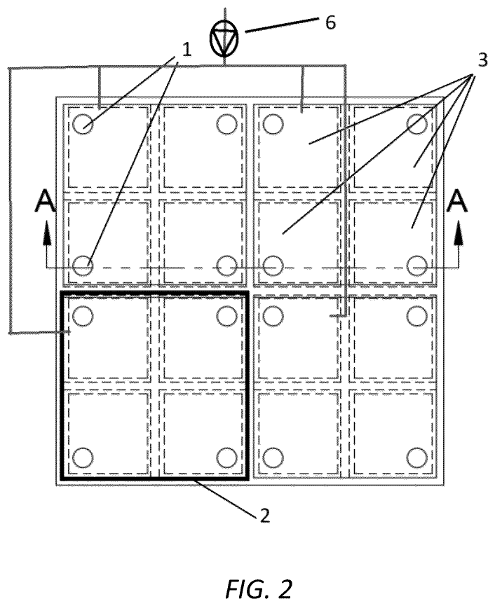

FIG. 2 provides a top-down view of an active-matrix configuration of the display device. The active-matrix configuration includes a grid of pixels, each defined by a visible pixel region 2. Each pixel is associated with an actuator 3 that regulates the amount of fluid entering its respective chamber. The fluid may be of different colors or clear, depending on the display requirements. The actuator 3 controls the flow of fluid from the sub-chamber through the orifice 1 into the visible pixel region 2. In one embodiment, the actuator 3 functions as a micro-pumping mechanism that actively drives the fluid from the sub-chamber into the pixel, allowing precise control over the color and intensity displayed by each pixel. In another embodiment, the actuator 3 operates as a microfluidic valve, which can be modulated to control the amount of fluid entering the visible pixel region 2, thereby adjusting the color output.

The fluids used within the display can be interconnected through a network of microchannels 6, shown in FIG. 2. These microchannels 6 are designed to deliver fluid of the same color to multiple pixels across the display. A centralized pump generates the necessary pressure to move the fluid through these microchannels 6 and into the individual pixel chambers. In this embodiment, the actuators 3 within each pixel serve as valves rather than individual pumps. When activated, these valve-like actuators 3 open to allow fluid from the microchannels 6 to flow into the pixel's visible region 2, filling the pixel with the desired color. The use of microchannels 6 allows for efficient distribution of fluids across the display, reducing the need for individual pumping mechanisms within each pixel and simplifying the overall design of the active-matrix display.

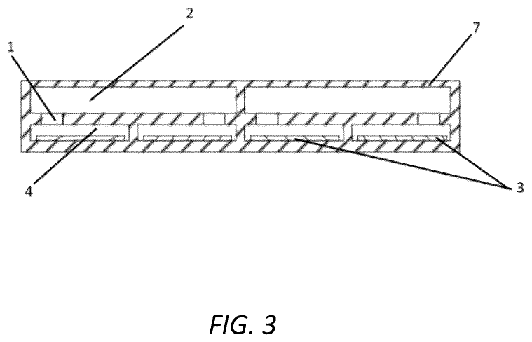

FIG. 3 shows a cross-sectional view along line A-A of FIG. 2, illustrating the visible pixel region 2, which is enclosed by the transparent top layer 7. The sub-chambers 4, where the fluid is stored before being moved into the visible pixel region 2, are also depicted. Fluid enters the visible pixel region 2 through the through-holes 1. Multiple through-holes 1 and sub-chambers 4 can be utilized to introduce different colored fluids into the same pixel. In another embodiment, a single fluid may be used per pixel, with each pixel being equipped with its own actuator 3 to manage the movement of the fluid into and out of the visible pixel region 2 as necessary. The actuators 3 can either propel the fluid into the visible pixel region 2 and then retract it or simply propel the fluid, allowing another fluid to push it back into the sub-chamber 4.

In one embodiment, a single fluid may be introduced into the visible pixel region 2, with the air in the pixel being compressed upon entry of the fluid. Alternatively, the pixel may include a mechanism or structure that allows the air to escape as the fluid enters, thereby preventing air compression and facilitating efficient fluid movement within the visible pixel region 2.

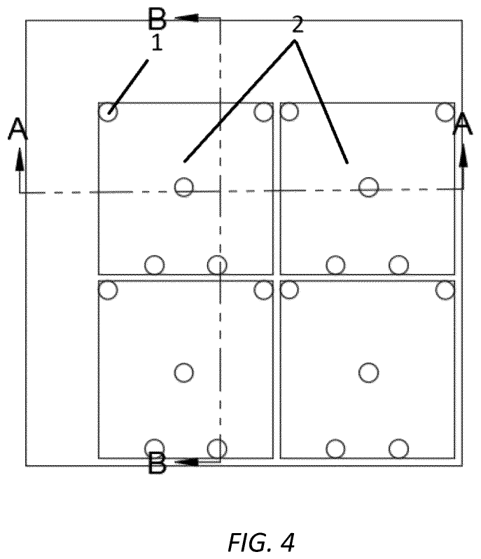

FIG. 4 illustrates a top-down view of a possible passive matrix display embodiment, where the number of actuators is reduced, and each pixel 2 in a row and column is fluidically connected via microfluidic channels (not shown in this figure). The through-holes 1 within each pixel 2 allow fluid to enter the visible pixel region and are arranged in a configuration that is flexible and can differ from the layout used in an active-matrix display. The arrangement of these through-holes 1 within the pixel 2 can be customized to suit specific design requirements, making the passive matrix layout adaptable to various display configurations.

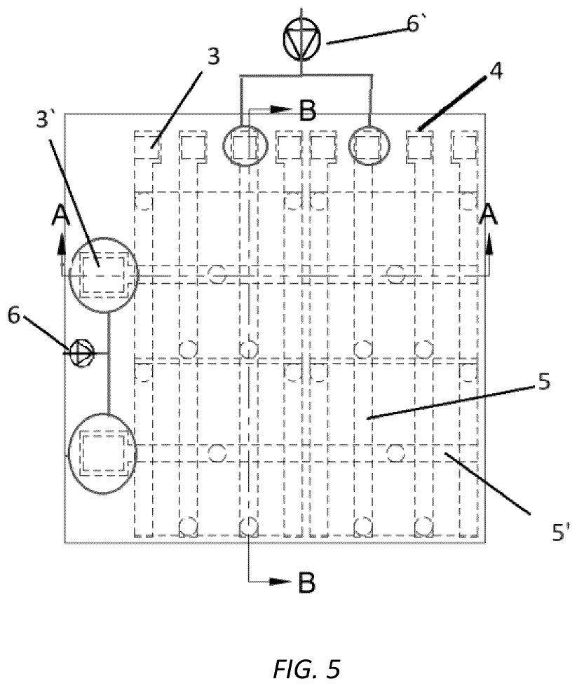

FIG. 5 provides a transparent top-down view of the passive matrix layout, detailing the placement of actuators 3 and 3′ along the microfluidic channels 5 and 5′. In this configuration, the actuators 3 and 3′ are located near the sub-chambers 4, which store the fluids before they are directed into the pixel regions. However, the actuators 3 and 3′ can also be placed at various positions along the microfluidic channels 5 and 5′ depending on the specific design requirements. The sub-chambers 4 can be included or omitted depending on the embodiment, offering flexibility in the system's design. This passive matrix configuration allows for selective activation of specific rows and columns, enabling the precise control of fluid flow into the desired pixels. Fluid can be directed to fill a single pixel by controlling which row and column actuators are engaged, thus offering fine-tuned control over the display output.

In one embodiment, the sub-chambers 4 may be connected in a closed loop configuration, allowing for the volume of fluid within the system to remain constant. In this design, when fluid is pumped into one pixel region, any fluid displaced from that pixel region is replaced by fluid from another part of the loop. This ensures balanced fluid distribution throughout the system and enables efficient management of fluid movement between the sub-chambers 4 and pixel regions, while maintaining consistent system volume.

In one embodiment, the actuators 3 and 3′ may operate as individual pumps, driving fluid from the sub-chambers 4 into the pixel regions. Depending on which actuators are activated, fluid flow through the microfluidic channels 5 and 5′ can be precisely controlled, allowing for the selective filling of specific pixels. However, in a preferred embodiment, the actuators 3 and 3′ function as valves that can be adjusted to various states-open, closed, or partially open. When paired with an additional pumping mechanism 6 and 6′, these valves allow for controlled fluid flow through the microfluidic channels 5 and 5′ and into the pixel regions. This setup provides an efficient and flexible means of managing fluid distribution across the display, enabling high-resolution control and reduced power consumption.

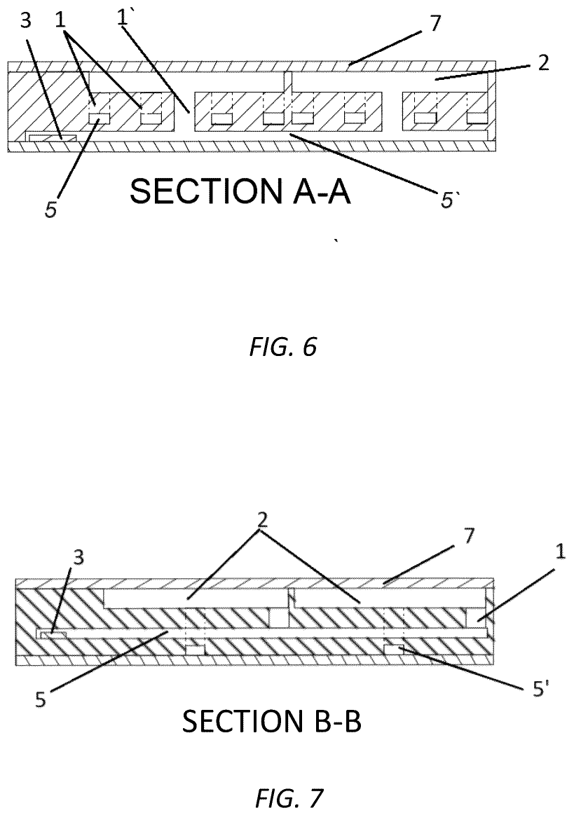

FIG. 6 illustrates a cross-sectional view of the passive matrix display along section A-A of FIG. 5. In FIG. 6, the microfluidic channels 5′ are shown running horizontally within the display at a specific depth. These channels 5′ are positioned within the sub-chambers 4, where the actuators 3 control the movement of fluids into the pixel regions 2. The through-holes 1 and 1′ connect these microfluidic channels 5 and 5′ to the visible pixel region 2 above, allowing fluids to move from the channels into the pixel region as controlled by the actuators 3. The transparent top layer 7 encloses the entire assembly, providing protection while allowing the pixels to be visible to an observer.

FIG. 7 illustrates a cross-sectional view of the passive matrix display along section B-B of FIG. 5. In FIG. 7, a similar configuration is depicted, but with the microfluidic channels 5 and 5′ running at multiple depths, ensuring that the different fluid types remain separated until they reach the pixel region 2. The microfluidic channels 5 and 5′ enable controlled fluid movement into the pixel region 2, which lies beneath the transparent enclosure 7. The channels may also be configured to run along the side walls of the pixel or even above the pixel region, depending on the specific design requirements. This multi-depth configuration allows for greater flexibility in fluid routing and ensures that different fluid types can be precisely controlled and directed into the pixel regions as needed, enhancing the display's performance and color accuracy.

FIG. 8 depicts another embodiment of the device showing a single pixel. In this configuration, the microfluidic channels are not limited to running beneath the pixel; they can also be positioned along the side walls of the pixel, or even on top. This flexibility in channel placement allows for various methods—either ‘active matrix’ or ‘passive matrix’—to be employed for fluid manipulation, depending on the specific design and operational requirements (these methods are not depicted in this figure).

FIG. 8 also highlights how the device can be integrated with a backlight to control the light that passes through the pixel. A color filter is placed above the pixel region, which modulates the color of light reaching the observer. The device operates by moving fluid into or out of the pixel chamber. As the fluid fills the chamber, it interacts with the backlight, reducing the brightness and light intensity visible to the observer. The backlight illuminates the fluid within the pixel chamber from behind, and the amount of light passing through the pixel can be modulated by the movement of the fluids. By adjusting the position of the fluids, the device controls how much backlight reaches the observer, offering finer control over brightness and visibility. In another embodiment, a reflective or colored material is positioned at the bottom of the pixel chamber. This material enhances the brightness of the display by reflecting light back toward the viewer. Additionally, the reflective material can be colored to contribute to the overall color output of the pixel. This feature allows for more vibrant colors or specific color effects, particularly when combined with the movement of immiscible fluids within the pixel.

In one embodiment, a transparent fluid may remain in the pixel region, while the moving fluid that blocks or reduces the backlight is introduced or removed. This ensures that the overall fluid volume within the pixel region remains constant. In the fully bright state, the transparent fluid allows the maximum amount of light to pass through. As the fluid increases in volume, the fluid reduces the backlight intensity, achieving darker states. This configuration maintains consistent fluid volume while providing precise control over brightness levels.

In another embodiment, the second fluid within the pixel is transparent and remains in the pixel chamber, while the movement of the first fluid, which may be colored or opaque, is used to modulate the amount of light passing through the pixel. This arrangement allows the device to control shading or grey-scale effects by varying the balance between the transparent and colored fluids. As the first fluid increases in the visible pixel region, it reduces the light transmitted through the pixel, creating a darker shade. Conversely, as the transparent fluid occupies the pixel, more light passes through, increasing brightness.

FIG. 8 also illustrates how one or more-color filters or color converters can be integrated into the device to create a color display. In this embodiment, each pixel functions similarly to an LCD display, where each pixel is equipped with an individual color filter or converter, such as red, green, blue, or other color combinations. These filters allow the pixel to act as a subpixel, contributing to the overall color output when combined with other subpixels.

As fluids move within the pixel, they interact with the color filter positioned above, modulating the light that passes through. By controlling the intensity and distribution of light with the fluid movement, the device can produce a wide range of color combinations. For example, if the fluid within a pixel interacts with a blue color filter, the pixel will primarily display blue. However, when combined with adjacent pixels containing red and green subpixels, the device can render any color combination by adjusting the light intensity and blending the outputs of these subpixels.

In FIG. 8, the concept of an individual subpixel is demonstrated, with a specific focus on blue production. However, in a complete pixel configuration, other subpixels, such as red and green, would be present to form a full-color pixel. This arrangement allows for dynamic color rendering, enhancing the versatility and capability of the display to produce vivid and accurate images.

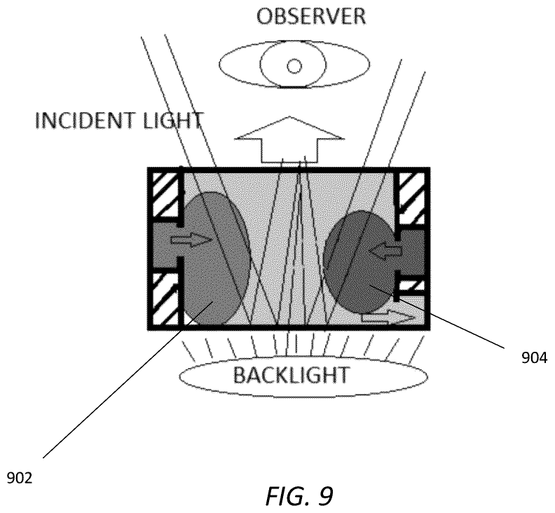

FIG. 9 illustrates how multiple fluids can coexist within a single pixel to create various color combinations. This can be accomplished by utilizing different types of immiscible fluids—such as oil, water, fluorocarbons, and others—that inherently do not mix or coalesce. Alternatively, the same or similar fluids may be used, with the addition of substances that prevent coalescence or merging, effectively allowing the fluids to remain separate while occupying the same pixel space.

These substances, which could include surfactants, stabilizers, particles, or other chemical additives, are employed to maintain the separation of the fluids, enabling them to interact with light independently. By doing so, the fluids can form distinct layers or regions within the pixel, each contributing to the overall color output as perceived by the observer. These additives prevent the fluids from coalescing or merging within the pixel chamber, maintaining the separation necessary for distinct color output. By employing such substances, the immiscible fluids interact with light independently, enhancing the accuracy and consistency of the colors displayed by the device.

For example, in the depicted configuration, two fluids 902 and 904 are shown within the pixel. As light passes through or reflects off these fluids, the colors blend, and the observer perceives a combination of the two colors. The backlight provides illumination from behind the pixel, while incident light from above can further influence the color and brightness observed.

The specific combination of fluids, additives, and light manipulation techniques used within the pixel allows for a wide range of color possibilities, effectively transforming the pixel into a dynamic element capable of rendering complex and vibrant images. This approach provides enhanced color accuracy and control, making the technology suitable for various applications, including high-definition displays and adaptive color-changing materials.

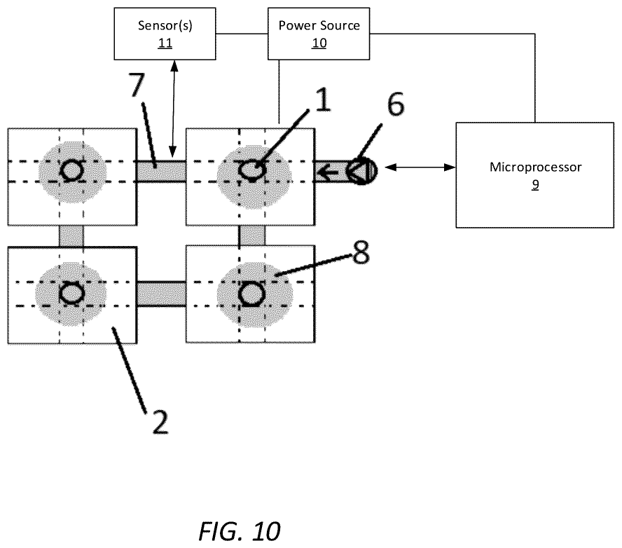

FIG. 10 illustrates a top-down view of the device functioning as a color-changing material that can be integrated onto a variety of surfaces. The device operates similarly to when it functions as a display. It includes through-holes labeled as reference number 1, which allow fluid to enter the pixel region denoted as reference number 2. The fluid is transported through the device by a pumping mechanism identified as reference number 6, which provides the necessary force to move the fluid through the microfluidic channels.

In one embodiment, the device operates as a color-changing material, similar to its function as a display, and can be integrated onto various surfaces. Fluid enters the pixel region 2 through the through-holes 1, with movement facilitated by a pumping mechanism 6 that provides the necessary force to direct the fluid through the microfluidic channels. To address the fluid dynamics, a second fluid is also present within the system (although not shown in this view, but illustrated in other FIGS.). As the primary fluid expands into the pixel region 2, the second fluid retracts into other areas of the device, ensuring balanced volume within the system. This interaction between the two fluids allows for efficient control of the color-changing effect, while maintaining consistent system fluid volume and ensuring optimal performance of the color-changing material.

FIG. 10 also illustrates hollow tube-like structures, labeled as reference number 7, which serve as microfluidic channels. These channels not only facilitate the transport of fluid but also provide the device with a high degree of flexibility and movement between adjacent pixels. This structural design enables the device to be effectively integrated onto curved surfaces, textiles, and various other flexible materials. The tube-like structures are designed to accommodate a range of shapes and thicknesses, thereby allowing for the required flexibility and movement between pixels.

The device can also include a microprocessor 9, which is responsible for managing and controlling the operation of the fluid-based display device. The microprocessor 9 is configured to process input data and generate control signals that govern the movement of fluids within the microfluidic channels. Specifically, the microprocessor 9 can execute algorithms that determine the desired color display based on input commands, adjusting the actuator mechanisms (such as the pumping mechanism 6) to position the first and second fluids within the chambers accordingly. This allows for precise control over the color and pattern displayed by the device, enabling dynamic changes in response to environmental conditions or user input. Additionally, the microprocessor 9 can be programmed to coordinate the operation of multiple pixels simultaneously, ensuring consistent color transitions and overall display performance. The integration of the microprocessor 9 enhances the functionality of the device by enabling it to operate autonomously, responding to predefined criteria or real-time data inputs, making it suitable for advanced applications such as wearable electronics, adaptive camouflage, and smart textiles.

The microprocessor 9 described herein can be utilized across various embodiments of the fluid-based display device, enhancing its versatility and functionality. In each embodiment, the microprocessor 9 serves as the central control unit, capable of managing the movement and positioning of fluids within the microfluidic channels to achieve the desired visual effects. Whether the device is implemented as a flexible, wearable display or integrated onto rigid surfaces, the microprocessor 9 processes input data and generates the necessary control signals to operate the actuator mechanisms, such as micro-pumps or actuating elements. This integration allows for dynamic color changes, pattern formations, and responsive adaptations to environmental stimuli across all embodiments. By incorporating the microprocessor 9, each embodiment gains the ability to autonomously adjust its display characteristics, whether in response to user commands, ambient light conditions, or other external inputs, thus broadening the range of potential applications and enhancing the overall performance of the device.

The power source 10, as referenced, is a component that supplies the necessary energy to operate the fluid-based display device across its various embodiments. Whether the device is designed as a flexible, wearable material or integrated onto a more rigid surface, the power source 10 provides the electrical power required to drive the microprocessor 9, actuator mechanisms, and other electronic components. In embodiments where the device is embedded in wearable fabrics, the power source 10 can be designed to be lightweight, flexible, and possibly rechargeable, ensuring that the overall flexibility and comfort of the wearable material are maintained. In more rigid or stationary applications, the power source 10 may be larger and capable of sustaining longer operational periods without frequent recharging. The power source 10 is capable of interfacing with the microprocessor 9 to optimize energy usage, dynamically adjusting power delivery based on the current operational demands of the device, such as during intense color transitions or when the device is in a low-power standby mode. This integration ensures that the device can maintain its functionality over extended periods while adapting to different use scenarios, further expanding the versatility of the fluid-based display technology.

In some embodiments, the device includes a sensor 11, which is configured to detect the position and/or movement of the fluids within the microfluidic channels or chambers. The sensor 11 communicates with the microprocessor 9, providing feedback that allows the microprocessor 9 to make real-time adjustments to the actuator mechanisms, such as the pumping mechanism 6. This feedback loop ensures that the desired color and pattern are accurately maintained across the display surface. The integration of the sensor 11 enhances the device's responsiveness to environmental changes or user inputs, further optimizing the display performance.

Any embodiment herein can include a combination of the microprocessor 9, the power source 10, and the sensor 11, working in unison to enhance the overall functionality of the fluid-based display device. The microprocessor 9 controls the movement and positioning of fluids within the microfluidic channels by processing input data and generating control signals, while the power source 10 provides the necessary energy to operate both the microprocessor and the actuator mechanisms. The sensor 11, integrated within the device, monitors the fluid positions or environmental conditions, providing real-time feedback to the microprocessor 9. This feedback loop enables precise control over the display output, allowing the device to dynamically adjust to changing conditions or user inputs, ensuring optimal performance across various applications, whether on flexible substrates, wearable electronics, or other surfaces.

In an alternative embodiment, the display technology leverages a hydraulically motivated pixelated system to control the visual output. This system utilizes a network of miniature pistons, each corresponding to an individual pixel within the display array. The pistons operate within a closed-loop hydraulic system designed to deliver precise control over pixel fluid movement, contributing to the display's overall stability and responsiveness.

Each pixel is linked to a hydraulic actuator driven by a fluidic pump mechanism. The hydraulic fluid, a non-compressible liquid specifically chosen for its low viscosity and temperature stability, circulates through the system. This closed-loop design ensures that the fluid remains contained within the system, thereby preventing leakage and maintaining consistent operational pressure. This consistency is critical for achieving uniform pixel movement across the display.

In one embodiment, the pistons are arranged in a matrix configuration, where a single microprocessor controls a number of pistons for a plurality of pixels. The microprocessor regulates the flow of the working fluid into groups of piston chambers. As the working fluid is pumped into a chamber, the corresponding piston extends, pushing the fluid into the pixel region 2, causing the pixel to become visible or adjust its brightness. As the primary fluid enters the pixel region, a second fluid is displaced, maintaining the overall fluid balance. When the fluid is withdrawn, the piston retracts, pulling the primary fluid back and lowering or turning off the pixel. This design allows for efficient control of multiple elements while maintaining smooth operation and consistent fluid dynamics across the display system.

This hydraulic system provides several advantages over conventional electronic displays. It is particularly effective in environments where electronic displays may suffer from reduced visibility or performance, such as under direct sunlight or in high-temperature conditions. The hydraulic system's mechanical nature allows it to maintain high visibility and functionality in such environments, offering a significant improvement in durability and energy efficiency.

Furthermore, the closed-loop design minimizes the need for frequent maintenance, as the system is sealed against contaminants and designed to operate continuously without significant wear on the components. This design also contributes to the display's longevity, as the hydraulic system is less prone to the failures that can affect electronic systems exposed to harsh conditions.

The use of hydraulic pistons also enables the display to exhibit a degree of physical flexibility, making it suitable for applications in wearable technology and other non-flat surfaces. This flexibility is achieved without compromising the display's resolution or performance, allowing it to conform to various shapes while maintaining consistent visual output.

As depicted, the thinning regions between the pixels contribute to the device's capability to conform to complex shapes and surfaces, enhancing its functionality as a color-changing material. The fluid flows through these channels to achieve the desired color change effect, and the positioning of the channels ensures that the fluid remains evenly distributed across the pixel regions.

In terms of manufacturing, this device presents significant advantages over traditional display technologies, as it does not rely on the expensive lithography techniques commonly used in OLED and LCD displays. The device, being a microfluidic system, can be fabricated using traditional micro-manufacturing methods such as soft lithography and stereolithography. Although standard lithography techniques may be utilized, they are not essential, allowing for a reduction in the complexity and cost of production. The materials required for this device are less exotic and less expensive than those used in traditional displays, leading to a more cost-effective manufacturing process.

The display and its associated microchannels can be produced on a micron scale using established manufacturing methods, which include but are not limited to injection molding, micro milling, 3D printing, laser etching, stereolithography, and chemical etching. The use of these manufacturing techniques ensures that the device can be produced efficiently and at a lower cost, making it suitable for a wide range of applications, from wearable electronics to adaptive materials for various surfaces.

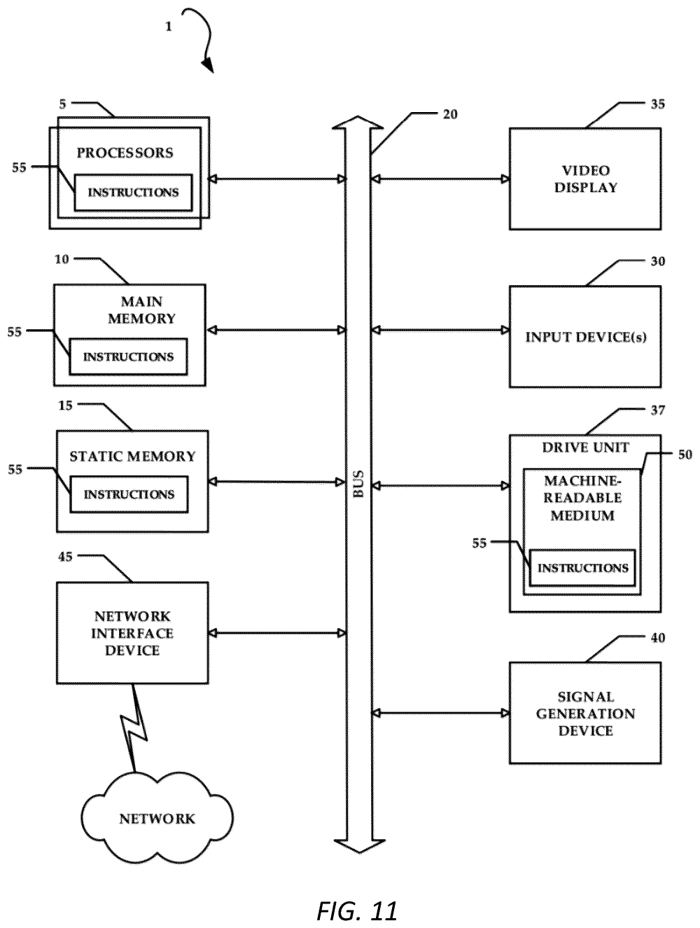

FIG. 11 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., any of the display devices recited herein). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, and I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A fluid-based display device comprising:
a plurality of pixels, each pixel comprising a chamber;
a first fluid of a first color and a second fluid of a second color and immiscible with the first fluid, within the chamber; and
an actuator configured to move the first and second fluids within the chamber to display a desired color, wherein the actuator is a fluidic actuator configured to control fluid movement and thereby control the first and second fluids within each pixel.

2. The display device of claim 1, wherein the actuator comprises a micro-pump or other fluidic actuator associated with each pixel, configured to alternately move the first fluid and the second fluid in and out of the chamber.

3. The display device of claim 1, further comprising a microprocessor programmed to control the actuator based on input data.

4. The display device of claim 1, wherein the pixels are arranged in an active-matrix configuration, with individual actuators provided for each pixel.

5. The display device of claim 1, further comprising a sensor configured to detect a position of the first and second fluids within the chamber and adjust the actuator accordingly.

6. The display device of claim 1, wherein the device includes a flexible substrate.

7. The display device of claim 1, wherein the second fluid is transparent, and the movement of the first and second fluids is used to control shading or grey-scale effects by modulating an amount of light passing through the pixel.

8. The display device of claim 1, wherein one or more additives, such as surfactants, stabilizers, or particles, are added to at least one of the fluids to render the fluids immiscible, preventing coalescence and maintaining fluid separation.

9. The display device of claim 1, further comprising a color filter positioned over the pixel to enable additional color combinations when displaying colors.

10. The display device of claim 1, further comprising a backlight system configured to modulate the amount of light passing through the pixel to enhance display visibility.

11. The display device of claim 1, wherein the pixel includes a reflective or colored material positioned at a bottom of the chamber to enhance a brightness or provide color effects.

12. A wearable display system comprising:
a flexible substrate;
a plurality of microfluidic pixels embedded within the flexible substrate, each pixel comprising at least two immiscible fluids of different colors or a combination of a transparent and colored fluid; and
an actuator system integrated into the flexible substrate, configured to control the position of the immiscible fluids within the pixels to display different colors or shades; and a microprocessor programmed to control the actuator system based on input signals.

13. The wearable display system of claim 12, further comprising a sensor for detecting ambient light conditions and adjusting the colors or shades displayed by the pixels accordingly.

14. The wearable display system of claim 12, wherein the system includes a power source embedded within the flexible substrate to power the actuator system and the microprocessor.

15. The wearable display system of claim 12, wherein the flexible substrate is configured to conform to non-planar surfaces, allowing the display to be integrated into wearable devices or other curved surfaces.

16. The wearable display system of claim 12, wherein the flexible substrate is composed of a material selected from polymers, elastomers, or composite materials.

17. The wearable display system of claim 12, further comprising microfluidic channels embedded within the flexible substrate, configured to transport the fluids between different pixels across the display.

18. The wearable display system of claim 12, wherein the flexible substrate allows the wearable display system to be woven into fabrics for integration into textiles and wearable electronics.

19. The wearable display system of claim 12, wherein the flexible substrate includes a protective layer configured to shield the display from environmental factors including moisture, dust, and/or physical impact.

20. The wearable display system of claim 12, wherein one of the at least two immiscible fluids are air.
